(19) United States
(12) Patent Application Publication
(10) Pub. No.: US 2007/0222762 A1
(43) Pub. Date: Sep. 27, 2007

(54) Touch Sensitive Display

(75) Inventors: Martinus Hermanus Wilhelmus Maria Van Delden, Eindhoven (NL); Jozef Thomas Martinus Van Beek, Eindhoven (NL); Galileo June Adeva Destura, Eindhoven (NL); Antonius Lucien Adrianus Maria Kemmeren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,827

(22) PCT Filed: Apr. 8, 2005
(86) PCT No.: PCT/IB05/51155

§ 371 Date: Oct. 11, 2006

(30) Foreign Application Priority Data
Apr. 14, 2004 (EP) 04101514.0

(51) Int. Cl. G06F 3/033

(52) U.S. Cl. 345/173

(57) ABSTRACT

There is provided a touch sensitive display comprising a passive substrate, an active substrate, and a display material disposed between the passive and active substrates, wherein driving circuitry for driving a pixel of the display and touch sensing circuitry are arranged on the active substrate. The touch sensing circuitry comprises at least one component with a first and a second electrode, wherein the electrodes are arranged to displace with respect to each other in response to a touch input.

### FIELD OF INVENTION

The present invention relates to a touch sensitive display.

### BACKGROUND OF INVENTION

The market for handheld and portable consumer electronics and computing has significantly diversified in the last decade. The trend has increasingly been towards smaller devices capable of displaying increasing amounts of information leading to improved displays having higher resolutions.

In addition, the user interface has progressed significantly and much effort has been put into providing an intuitive interaction mechanism. A frequently used method for receiving user inputs is by incorporating a touch screen at the device. This allows for a user interaction by the user touching a touch sensitive display.

WO 03/079449 A1 discloses an AM electroluminescent display device comprising a pressure sensor structure comprising a transparent upper electrode layer, an underlying conductive barrier layer, and a compressible layer of dielectric or highly resistive material stacked between the transparent upper electrode layer and the underlying conductive barrier layer. This stack is positioned between a viewer and a circuit substrate on which an array of electroluminescent pixels is present. When pressure is applied to this stack, the spacing between the electrode layer and the conductive barrier material changes, causing a measurable change in capacitance across the dielectric or reduction in resistance across a highly resistive material for electrodes adjacent to the touch point. The display device comprises a number of layers resulting in a significant increase in the thickness of the resulting touch sensitive display. This degrades the optical performance of the touch sensitive display and requires that materials having suitable optical properties are used to implement the touch screen.

A problem is that the performance of the touch sensitive display of the prior art do not meet requirements of spatial resolution, low thickness, and visual performance.

### SUMMARY OF THE INVENTION

It is therefore an object of the present invention to provide a touch sensitive display with improved properties in terms of spatial resolution, low thickness, and visual performance.

According to a first aspect of the present invention, there is provided a touch sensitive display comprising an active substrate, wherein driving circuitry for driving a pixel of the display and touch sensing circuitry are arranged on the active substrate. The touch sensing circuitry comprises at least one component with a first and a second electrode, wherein the electrodes are arranged to displace with respect to each other in response to a touch input.

Integrating the touch sensing circuitry and the driving circuitry on an active substrate will enable a compact touch sensitive display with essentially reduced thickness since no additional touch sensing layers need to be added. Spatially more precise touch sensing is also provided due to the reduced thickness, as well as improved visual performance due to reduction of layers between a display material and a viewer.

A further advantage of the touch sensitive display according to the invention is that no calibration is needed since driving circuitry and touch sensing circuitry have a fixed spatial relation to each other, i.e. are arranged pixel-wise. In this case, the electrode displacement enables touch input to be detectable for each pixel. In particular, touch input can be detected by detecting impedance changes in the touch sensing circuitry. Means for detecting a touch input may be arranged on the active substrate, or outside the display device, e.g. in an electronic device comprising the display device.

A pressure concentrator may be arranged between a passive substrate and the first electrode to transmit an applied force between the passive substrate and the touch sensing circuitry.

This will improve transmission of force from the touched surface to the touch sensing circuitry.

The touch sensing circuitry may comprise a capacitor comprising the first and second electrodes. The capacitor may comprise at least one dielectric layer between the first and second electrodes. At least one of said dielectric layers may comprise a recess forming a gap between the electrodes.

These features will enable neat implementations of the touch sensing circuitry.

The capacitor may also be operable as a storage capacitor in the driving circuitry.

This will enable a more compact solution.

A first dielectric material with a first dielectric and mechanical characteristic and a second dielectric material with a second dielectric and mechanical characteristic may be arranged between the electrodes.

This will enable a robust touch sensing circuitry with more predictable characteristics.

The first dielectric layer may comprise a first recess covering a part of an area between the first and second electrodes, and the second dielectric layer comprises a second recess covering the same part of the area between the first and second electrodes, wherein the first and second recesses form the gap between the electrodes.

This will enable a touch sensing circuitry with a predetermined impedance when no touch input is present; and a dynamic part for touch sensing purposes to provide improved manageable electrical properties.

The touching circuitry may comprise a sacrificial transistor comprising the first and second electrodes, wherein the sacrificial transistor is provided with a gap between the first and second electrodes.

This will provide a neat implementation of the touch sensing circuitry.

The sacrificial transistor may comprise at least one of an amorphous silicon (a-Si) layer and a dielectric layer between said first and second electrodes. At least one of the a-Si layer or dielectric layer may comprise a recess forming the gap.

This implementation is well suited for integrating into ordinary manufacturing processes.

The sacrificial transistor may be a thin-film transistor (TFT).

Thin film technology is well suited for implementing the present invention.

A particular feature of the present invention is to provide a display with integrated touch sensitive elements.

A particular advantage of the present invention is that a touch sensitive display having reduced thickness is achieved. A further advantage is reduced manufacturing costs for touch sensing displays, since both driving circuitry and touch sensing circuitry can be made on the active substrate in the same process. A further advantage is high accuracy and high resolution of detection of a touched point, since each touch sensing circuitry can be associated with a pixel. A further advantage is maintained resolution and definition of the displayed image when introducing touch sensing features in an active matrix (AM) display technology. These multi-layer thin-film AM technologies are attractive because of the possibility to integrate the display drivers, the peripheral driving electronics, and additional functionalities, for example a touch sensitive element, into the display itself.

According to another feature of the invention, the detection means is operable to detect a plurality of simultaneous touch points. Preferably the detection means can simultaneously detect changed capacitances between a plurality of pairs of first and second electrodes. This is possible due to the active matrix structure of the display and its integrated touch sensors. An advantage of this is increased flexibility and improved functionality of a device comprising the touch sensitive display.

According to a different feature of the invention, a plurality of touch sensors is aligned with a corresponding plurality of pixels of the active matrix display. This may allow for a very simple and accurate correspondence between touch sensitive elements and a displayed image and may obviate or mitigate the requirement for calibration. Preferably, the alignment is achieved by aligning the touch sensitive elements with the storage capacitor and/or sacrificial TFT of the active matrix display element.

According to a feature of the invention, the touch sensitive element comprises a Micro-Electromechanical (MEM) capacitor or sacrificial TFT operable to modify their capacitance. This allows for a particularly suitable implementation. Specifically, it provides process compatibility. Thus, reduced manufacturing complexity and cost for touch sensitive displays, e.g. amorphous silicon based active matrix displays, are achieved.

These and other aspects, features and advantages of the invention will be apparent from and elucidated with reference to the embodiments described hereinafter.

### BRIEF DESCRIPTION OF THE DRAWINGS

FIG. 1 shows a typical AMLCD.

FIG. 2 shows one principle according to the present invention.

FIG. 3 shows another principle according to the present invention.

FIG. 4 shows a touch sensor integrated in a storage capacitor according to one embodiment of the present invention.

FIG. 5 shows a touch sensor integrated in a storage capacitor according to another embodiment of the present invention.

FIG. 6 shows a touch sensor integrated in a storage capacitor according to further an embodiment of the present invention.

FIG. 7 shows a touch sensor integrated in a sacrificial TFT according to one embodiment of the present invention.

### DETAILED DESCRIPTION OF PREFERRED EMBODIMENTS

The drive for displays capable of combining high performance, high-speed video, large size and low power, pushes display technology into the direction of Active Matrix (AM) Liquid Crystal Display (LCD) technologies. The present invention is applicable to various active matrix display devices. The following specific embodiments will describe the invention in relation to an active matrix liquid crystal display (AMLCD) device by way of example only. It will be appreciated that other types of active matrix display devices can be employed, e.g. devices using electrophoretic ink, polyLED, OLED, plasma display, and flexible version thereof.

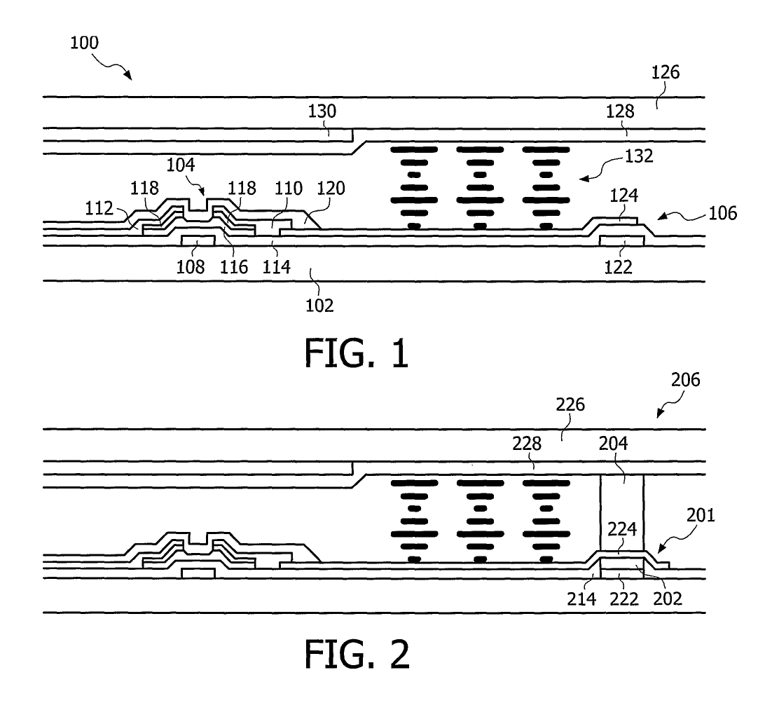

In order to illustrate the integration of touch-sensing features into an AMLCD technology, reference is made to FIG. 1 showing a schematic cross sectional view of a typical AMLCD 100. A liquid crystal 132 is sandwiched between a passive substrate 126 and an active substrate 102. Furthermore, each pixel is provided with a driving TFT 104 and a storage capacitor 106 supported on the active substrate 102.

The driving TFT 104 comprises a gate 108 and two electrodes 110, 112, of which electrodes one will work as source and the other as drain. The driving TFT 104 further comprises a first dielectric layer 114, an amorphous silicon (a-Si) layer 116, a second dielectric layer 118, and a passivation layer 120.

The storage capacitor 106 comprises a first electrode 122, the first dielectric layer 114, and a second electrode 124.

The AMLCD 100 further comprises a passive substrate 126 that comprises a color filter 128, and a black matrix layer 130. The black matrix may serve several purposes, e.g. shielding the TFT from external light, hiding the TFT and interconnect column and row connections from the viewer, and improving contrast and color purity.

A stack of thin films is deposited and structured on a the active substrate in order to form TFT and storage capacitors. These components comprise at least three layers, of which two are conductive and one is insulating. Thus, at least two conductive terminals are available to make a touch sensor feasible.

The general idea of the invention is that conversion of a force applied when touching the screen into an electric signal is achieved by a Micromachined Electro Mechanical (MEM) element, e.g. a capacitive MEM sensor or a MEM switch.

A MEM sensor comprises two electrodes facing each other, wherein one of the electrodes can move in a given direction. When a force is applied on one of the electrodes, the faces of the electrodes move towards each other, and thus increasing the capacitance value of the sensor, or in case of a switch ultimately connect the two electrodes, thereby forming a resistive connection. Thus a change in impedance is achieved upon touch, which can be detected. As the sensors are associated to the pixels, the position of the touch can be accurately determined.

MEM capacitors or MEM switches are feasible in thin-film integrated circuits, and only require a few mask steps. MEM capacitors or MEM switches are further relatively cheap, fast, small size, low-loss and low power consuming. These features make them feasible for integration into AMLCD technology touch-sensing displays.

MEM capacitors are normally used as actuators, where an electric field is used to change their impedance properties. In the present invention, instead, they are used as sensors. Thus, a sensor may be provided at each pixel.

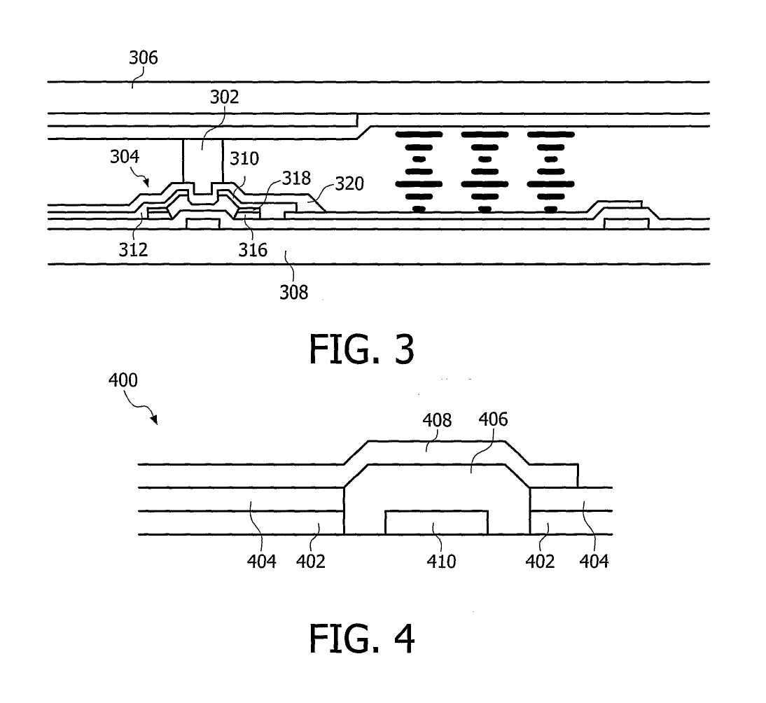

In order to make a capacitive MEM sensor, one or more sacrificial layers can be removed from a stack of dielectric layers sandwiched between two anchored electrodes by means of etching at a given location. The etching can be wet or dry etching. In an AMLCD, this can be done at either a storage capacitor as shown in FIG. 2, or at a sacrificial TFT at a TFT structure comprising a driving TFT and a sacrificial TFT, as shown in FIG. 3, or both (not shown). Note that the driving TFT is not shown in FIG. 3. Alternatively, a dedicated MEM sensor structure may be introduced (not shown) such that the driving TFT and/or storage capacitor are not modified in order to accommodate the MEM sensor.

FIG. 2 shows one example of a touch sensor according to the present invention, where the touch sensor is integrated into a storage capacitor 201. The basic principle is that a part of the dielectric layer 214 is removed between the first and second capacitor electrodes 222, 224 to provide a gap 202. A pressure concentrator 204 is provided between a passive substrate 206, comprising the color filter substrate 226 and the color filter 228, and the second capacitor electrode 224. When the passive substrate 206 is touched, a force will be transmitted via the pressure concentrator 204 to the second capacitor electrode 224. Thus, the second capacitor electrode 224 will be displaced and the capacitance of the capacitor 201 will change. The change in capacitance is then able to be detected, and thus the touched position of the display. Further, the pressure concentrator 204 is also operable as a spacer between passive and active substrates of the display.

FIG. 3 shows another principle according to the present invention, where the touch sensor is formed by a sacrificial TFT 304 on an active substrate 308, i.e. adding a further TFT to each pixel. A part of a a-Si layer 316, dielectric layers 318, or both are removed. A pressure concentrator 302 is provided between a passive substrate 306 and the passivation layer 320. When the passive substrate 306 is touched, a force will be transmitted via the pressure concentrator 302 to the passivation layer 320 of the sacrificial TFT 304. Alternatively, if the active substrate 308 is touched, a reactive force is transmitted via the pressure concentrator 302 to the passivation layer 320 of the sacrificial TFT 304. Thus, electrodes 310, 312 will be displaced and the capacitance of the sacrificial TFT 304 will change. The change in capacitance is then able to be detected, and thus the touched position of the display. Further, the pressure concentrator 302 is also operable as a spacer between passive and active substrates of the display.

A storage capacitor structure 400, with increased overall size, comprising a first dielectric layer 402 and a second dielectric layer 404, where both the dielectric layers 402, 404 are removed at the location 406 of the storage capacitor according to one embodiment of the present invention is shown in FIG. 4. The sensor is designed such that it has equal capacitance, when untouched, as a typical storage capacitor of a typical pixel would have. When the sensor is touched, the capacitance increases inversely proportional to the displacement of the actuated electrode 408 of capacitor 400. At large displacement of the electrode 408, the surfaces of the capacitor electrodes 408, 410 will contact, and an electrical short-circuit or dramatically decreased isolation resistance will be able to be detected between said two capacitor electrodes instead of a capacitance value.

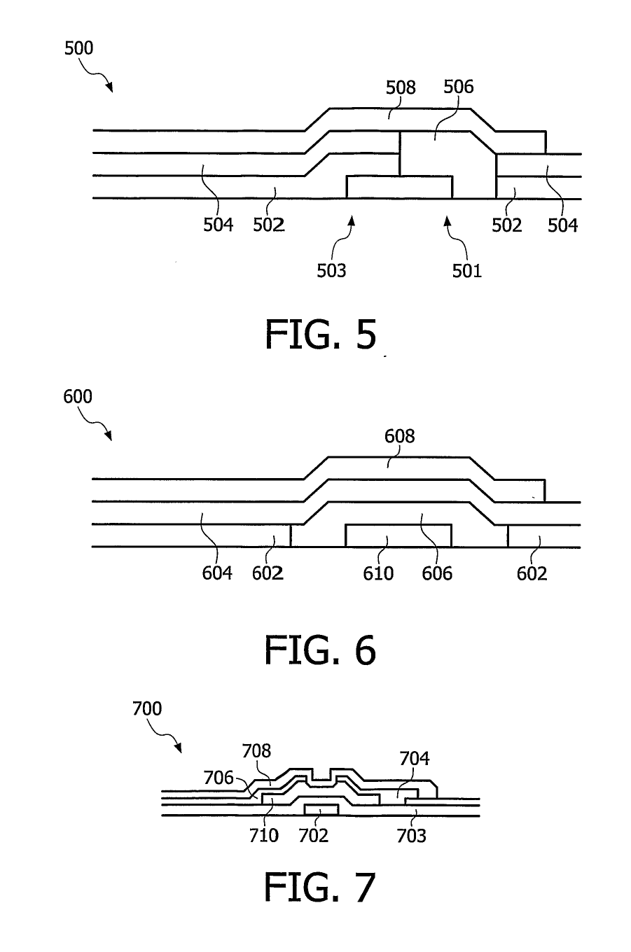

FIG. 5 shows a further embodiment of the present invention, wherein a structure 500 similar to structure 400 is operable both as a touch sensor and as storage capacitor. When the sensor is untouched, the capacitance from section 503 and 501 will give a total capacitance value equal to a capacitance value for a typical storage capacitor, as used in a typical pixel. The structure 500 will require one extra mask step for providing access holes towards the first and/or second dielectric layers 502, 504. A part 506 of both the dielectric layers 502, 504 is removed. Thus, there is a is fixed capacitance 503 of the storage capacitor provided at the part where the dielectric layers 502, 504 are remaining, and a variable capacitor part 501, that acts as a capacitive sensor and as a part of the storage capacitor, provided that the dielectric layers at part 506 are removed. When the sensor is touched, the capacitance of the sensor part 501 increases inversely proportional to the displacement of the actuated electrode 508 of the sensor. Thus, the overall capacitance of part 503 and 501, which are connected in parallel will increase. Depending on the ratio of the parts 503 and 501, a sensor may be constructed requiring a larger or a smaller displacement of the actuated electrode 508 to enable detection of a significant change of the capacitance. Thus, a feasible actuation force of the touch sensor may be achieved. Some users prefer a soft touch, and other users prefer a hard touch. Thus, depending upon how much of the dielectric is removed, more or less force is required to actually detect a touch. In other words, the minimum force that is needed is pre-set at the manufacturing, and can not be changed. In all cases, however, a threshold value of e.g. 1.2 pF must be exceeded.

FIG. 6 shows a further embodiment of the present invention, with a dedicated structure 600 similar to structure 500. The structure 600 can also act as a sensor and a storage capacitor. Making this structure 600 will require one extra mask step for providing access holes towards a first and second dielectric layers 602, 604. One of the dielectric layers 602, 604 is removed, e.g. the first dielectric layer 602. When the sensor is untouched, the capacitance value is equal to that of a typical storage capacitor of a typical pixel, and is dominated by the medium in the recess 606, preferably having a small dielectric constant (close to one). It should be noted that the medium in the recess can be any compliant material. When the sensor is touched and a second capacitor electrode 608 and the second dielectric layer 604 are displaced, the capacitance of the sensor 600 becomes more and more dominated by the dielectric layer 604, resulting in an increased capacitance value. In this example, the compliant material has a dielectric constant smaller than that of the first and/or second dielectric material used in the storage capacitor. In assuming that for example LC material having a dielectric constant of 10 would be in the recess, the first and second dielectric must have dielectric constant of about 25. However, a compliant material having a dielectric constant which is higher than that of the first and/or second dielectric material used in the storage capacitor can also be considered.

The remaining dielectric layer 604 offers an additional mechanical support for the displaced electrode 608, which is important with respect to the mechanical stability of the sensor 600. The electric equivalent circuit of the sensor structure 600 is two capacitors in series, with one capacitor formed by the electrode 610 and the recess 606 in series with a second fixed capacitor formed by the second dielectric layer 604 and electrode 608. An advantage of structure 600 is that it provides a large change of the capacitance. The effective capacitance C_{eff} as a function of displacement can be calculated using a sensor area A with total gap d and dielectric constant ε₀ series with a storage capacitor (the remaining dielectric layer 604) with dielectric constant εᵣ and thickness d¹:

$${C}_{eff} = \frac{{ɛ}_{0} A / d}{1 - ( 1 - 1 / {ɛ}_{r} ) {d}_{{ɛ}_{r}} / {d}^{1}} \qquad ( 1 )$$

In general, the storage capacitor in an AMLCD has a capacitance equal to that of a pixel in the off-state, e.g. 265 fF, such that the pixel content is maintained in the non-driving part of the display update cycle. Thus, the capacitive load of the TFT is about 531 fF in the off-state. In the on-state, the typical pixel capacitance is about doubled due to anisotropy of dielectric constant of the liquid crystal. The load of the TFT is increased to about 800 fF when the pixel is in the on-state. A typical driving TFT is designed to handle about 1 pF.

Detecting a change in a capacitance of a pixel does not necessary mean that the pixel has been touched, without considering its content. This can be solved by a storage memory, which will raise display module cost. An advantage of the present invention is that a storage memory is not needed. In the present invention, the change in capacitance can be increased well over the driving capacity of the TFT, which can be detected. Preferably, the increase is 50% or more than the capacitance of the pixel in the on-state. When overloading the driving TFT, it is only needed to know that the TFT is overloaded by measuring the load current to the capacitor and not the capacitance value of the load, and current sensing circuits are very fast.

According to a further embodiment, one of the TFTs associated with the pixel is used as a sacrificial TFT, i.e. an additional TFT of the pixel, to form a sensor. FIG. 7 shows a TFT structure 700 of the sacrificial TFT, comprising a gate 702, a dielectric layer 703, a first electrode 704, a second electrode 706, of which one electrode will work as source and the other as drain, a passivation layer 708, and a gap 710. Similar to the above described embodiments, a capacitance change is detected when the screen is touched, but detected in the TFT electronics, i.e. in the sacrificial TFT. An advantage of this embodiment is that additional parts, such as pressure concentrators are hidden under the black matrix mask. An effect to consider here is the increased gate capacitance of the driving TFT of the pixel, thereby resulting in changed dynamics of the pixel.

According to a further embodiment, a second mask step is added for providing a pressure concentrator at a position of the touch sensor. Other features are similar to those of any of the above described embodiments. An advantage of this embodiment is that conventional spacers e.g. glass spheres, do not have to be used in order to define the cell gap, which may result in easier manufacturing.

The AMLCD is manufactured conventionally, but with an additional mask step for providing holes towards sacrificial layers of the storage capacitor or the sacrificial TFT for providing a gap. The sacrificial layer is either one or more of the dielectric layers of a storage capacitor, or the a-Si layer and one or more of the dielectric layers of a sacrificial TFT. One of the embodiments of the present inventions further-comprises a second additional mask step for providing the pressure concentrator arranged between the passive substrate of the display and the sacrificial TFT or storage capacitor operable as the touch sensor to transmit an applied force between the passive substrate and the touch sensor. Thus, the pressure concentrator is located at the touch sensor. An advantage of this is that no separate spacers, e.g. glass spheres, are needed in order to define the cell gap.

The optical properties of the pressure concentrator on top of the touch sensitive element are significant when visible to the user when in between the viewer and the active matrix display element. This is often the case when the touch element is integrated at the storage capacitor, and therefore the pressure concentrator is preferably made of a translucent material.

In the case of a sacrificial TFT on the other hand the pressure concentrator and touch sensitive element are disposed away from the viewer by means of a light shield, for example the black matrix mask, and is thus not between the viewer and the active matrix display.

Thus, in this particular case the optical properties of the touch sensitive element are not significant and specifically the touch sensitive element and pressure concentrator may for example be made of semi-translucent or opaque materials. Hence, an improved image of the display may be obtained.

The touch sensitive display comprises a plurality of touch sensors. A practical and convenient implementation wherein position determination is based on detecting a changed capacitance associated with the touch sensors. Electrical signals from the touch sensors are electrical changes and associated sense amplifiers are preferably charge sensitive amplifiers. This provides for a particularly suitable detection of a changed capacitance.

A portable device comprising a touch sensitive display as described above provides an example where the invention fills a particularly useful purpose. With the possibility to provide a thin display, with touch sensing features, and at a moderate cost, the invention will enable provision of an eligible portable device, e.g. a mobile telephone, a personal digital assistant, a lap-top computer, a digital camera, a video camera recorder, a media player or an electronic measuring device.

1. A touch sensitive display comprising an active substrate (102, 308), wherein driving circuitry (104) for driving a pixel of said display and touch sensing circuitry (201, 304) are arranged on said active substrate (102, 308), wherein said touch sensing circuitry (201, 304) comprises at least one component with a first and a second electrode (224, 310, 408, 410, 508, 608, 610, 702, 704, 706), wherein said electrodes (224, 310, 312, 408, 410, 508, 608, 610, 702, 704, 706) are arranged to displace with respect to each other in response to a touch input.

2. Touch sensitive display according to claim 1, further comprising a passive substrate, wherein a pressure concentrator (204, 302) is arranged between said passive substrate (206, 306) and said first electrode (224, 310, 312) to transmit an applied force between said passive substrate (206, 306) and said touch sensing circuitry (201, 304).

3. Touch sensitive display according to claim 1, wherein said touch sensing circuitry (201, 304) comprises a capacitor (201, 400, 500, 600) comprising said first and second electrodes (224, 408, 410, 508, 608, 610), wherein said capacitor (201, 400, 500, 600) comprises at least one dielectric layer (402, 404, 502, 504, 602, 604) between said first and second electrodes (224, 408, 410, 508, 608, 610), wherein at least one of said dielectric layers (402, 404, 502, 504, 602, 604) comprises a recess (202, 406, 506, 606) forming a gap between said electrodes (224, 408, 410, 508, 608, 610).

4. Touch sensitive display according to claim 3, wherein said capacitor (201, 400, 500, 600) also is operable as a storage capacitor in said driving circuitry.

5. Touch sensitive display according to claim 1, wherein a first dielectric material (502, 602, 703) with a first dielectric and mechanical characteristic and a second dielectric material (504, 604, 704) with a second dielectric and mechanical characteristic are arranged between said electrodes.

6. Touch sensitive display according to claim 5, wherein said first dielectric layer (502) comprises a first recess (506) covering a part of an area between said first and second electrodes representing the capacitance of said capacitor, and said second dielectric layer (504) comprises a second recess (506) covering the same part of said area between said first and second electrodes, wherein said first and second recesses (506) form said gap between said electrodes.

7. Touch sensitive display according to claim 1, wherein said touch sensing circuitry comprises a sacrificial transistor (304, 700) comprising said first and second electrodes (310, 312, 702, 704, 706), wherein said sacrificial transistor (304, 700) is provided with a gap (710) between said first and second electrodes (310, 312, 702, 704, 706).

8. Touch sensitive display according to claim 7, wherein said sacrificial transistor (304, 700) comprises at least one of an amorphous silicon (a-Si) layer (316) and a dielectric layer (318, 703) between said first and second electrodes (310, 312, 702, 704, 706), wherein at least one of said a-Si layer (316) and said dielectric layer (318, 703) comprises a recess (710) forming said gap.

9. Touch sensitive display according to claim 7, wherein said sacrificial transistor (304, 700) is a thin-film transistor (TFT).
